(19) United States
(12) Patent Application Publication
(10) Pub. No.: US 2007/0114477 A1
(43) Pub. Date: May 24, 2007

(54) ENHANCED SENSITIVITY OF A WHISPERING GALLERY MODE MICROSPHERE SENSOR BY A HIGH-REFRACTIVE INDEX SURFACE LAYER

(76) Inventors: Iwao Teraoka, Rye, NY (US); Stephen Arnold, New York, NY (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/561,087

(22) Filed: Nov. 17, 2006

Related U.S. Application Data
(60) Provisional application No. 60/737,487, filed on Nov. 18, 2005.

(51) Int. Cl. G03C 5/16; G01N 23/04

(52) U.S. Cl. 250/580

(57) ABSTRACT

The use of whispering gallery mode (WGM) evanescent waves to detect adsorption of molecules to the surface of microsphere sensors and more particularly to the utilization of a high refractive index surface layer to increase the sensitivity thereof. The present invention examines the sensor capability of WGM in a dielectric sphere coated with a thin uniform dielectric layer of a high refractive index. Among the utilities of such a modified resonator for the sensing are to have an evanescent field of a different penetration depth without using a non-silica based microsphere or changing the laser wavelength, to further enhance the sensitivity by drawing the optical field of WGM into the coating layer, and to realize the same relative shifts for WGM of different radial modes, thus eliminating ambiguities in the measurement of a refractive index change in the surrounding medium.

### RELATED APPLICATION

This application claims benefit to U.S. Provisional Application Ser. No. 60/737,487, titled “A HIGH REFRACTIVE INDEX LAYER IN WHISPERING GALLERY MODE PHOTONIC SENSORS”, filed 18 Nov. 2005 and listing Iwao Teraoka and Stephen Arnold as the inventors. That application is expressly incorporated herein by reference. The scope of the present invention is not limited to any requirements of the specific embodiments in that application.

### FEDERAL FUNDING

This invention was made with Government support and the Government may have certain rights in the invention as provided for by grand number BES-0522668 awarded by the National Science Foundation.

### BACKGROUND OF THE INVENTION

1. Technical Field

The present invention is directed generally to the use of whispering gallery mode (WGM) evanescent waves to detect adsorption of molecules to the surface of microsphere sensors and more particularly to the utilization of a high refractive index surface layer to increase the sensitivity thereof.

2. Related Art

Molecular absorption spectroscopy is an analytical method that is based on the observation that individual chemical species preferentially absorbs certain wavelengths of incident light radiation. Furthermore, the suite of light frequencies absorbed by a compound can often be used to uniquely identify it. Thus, spectrographic analysis of an unknown sample by exposing the sample to light of different frequencies is a well known way of ascertaining the identity of that sample.

Of particular interest to the present disclosure is the topic of optical evanescent-wave sensors and their use in absorption spectroscopy. As is well known to those skilled in the art, when light is incident on a medium at an angle of incidence that is greater than the critical angle, Snell's law suggests that all of the light will be reflected internally at that interface, i.e., total internal reflection. However, Fresnel's equations (in concert with Maxwell's equations) predict, and in fact it is observed in practice, that evanescent waves will be generated at the point of total reflection. The energy of this type of wave penetrates beyond the surface of the reflecting medium and returns to its original medium unless a second medium is introduced into the region of penetration of the evanescent wave. In other words, if another medium is brought near enough to the point where total internal reflection occurs, energy in the form of evanescent waves of the same optical frequency as the incident light will be transmitted to the second medium.

“Whispering-gallery” modes of light propagation are waves, with an evanescent component, that may be qualitatively described as traveling waves which propagate within a bent dielectric waveguide that closes upon itself (e.g., a sphere), with the energy confinement and guiding occurring by a physical mechanism not unlike total internal reflection in optical systems. These modes can have extremely low transmission losses, allowing such spheres to be used as microresonators. If molecules are brought into sufficient proximity to the surface of a microsphere in which evanescent waves are propagating, the molecules may interact with those waves and attenuate them to the extent that these molecules would absorb the same wavelength in conventional light, i.e., absorption spectroscopy. Further, the high quality factor of the microsphere means that even a single atom or molecule interacting with a WG mode can potentially have a significant effect on the energy of that mode. In an alternative embodiment, interaction of the WG mode with molecules in its evanescent field may polarize such molecules thereby inducing a measurable frequency shift which may ultimately lead to single molecule detection.

Given this, there is a growing activity in one area of research using a resonance frequency shift of a whispering gallery mode in a highly symmetric dielectric medium for sensing of molecular adsorption, refractive index, and stress. For example, when a molecule adsorbs onto the surface of a dielectric resonator, the evanescent field of the resonance mode polarizes the molecule. When the medium surrounding the resonator changes its refractive index, the polarization by the evanescent field changes. The change in polarization near the resonator surface lays the foundation for WGM frequency-shift sensors. An extremely narrow linewidth in the symmetric resonator provides the WGM sensor with a high sensitivity.

Two pending U.S. patent applications are of particular interest in this area, including U.S. Patent Application Pub. No. 2003/0174923 entitled DETECTING AND/OR MEASURING A SUBSTANCE BASED ON A RESONANCE SHIFT OF PHOTONS ORBITING WITHIN A MICROSPHERE to inventors Arnold and Teraoka; and U.S. Patent Application Pub. No. 2004/0137478 entitled EHANCING THE SENSITIVITY OF A MICROSPHERE SENSOR to inventors Arnold, Teraoka and Vollmer. The disclosures of these published patent applications are hereby incorporated in their entirety by reference.

It would be highly desirable to increase the sensitivity of the WGM sensor. The present invention addresses this need. Accordingly, the present invention provides WGM in silica microspheres suspended in water that can detect adsorption of protein molecules from an aqueous solution and a refractive index change of the solution with a sensitivity sufficiently high to potentially allow detection of a single molecule of molecular weight below one million g/mol.

### BRIEF SUMMARY OF THE INVENTION

The present invention is directed generally to the use of whispering gallery mode (WGM) evanescent waves to detect adsorption of molecules to the surface of microsphere sensors and more particularly to the utilization of a high refractive index surface layer to increase the sensitivity thereof. The present invention examines the sensor capability of WGM in a dielectric sphere coated with a thin uniform dielectric layer of a high refractive index. We envision three utilities of such a modified resonator for the sensing. The first is to have an evanescent field of a different penetration depth without using a non-silica based microsphere or changing the laser wavelength. The second is to further enhance the sensitivity by drawing the optical field of WGM into the coating layer. The third is to realize the same relative shifts for WGM of different radial modes, thus eliminating ambiguities in the measurement of a refractive index change in the surrounding medium. The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 illustrates an increasing penetration depth of the evanescent wave with increasing mode number for a given wavelength of light.

FIG. 2A presents a plot of the wave vector, k, at resonance as a function of the thickness, t, of the dielectric layer for different values of n₃, for mode υ=1.

FIG. 2B presents a plot of the wave vector, k, at resonance as a function of the thickness, t, of the dielectric layer for different values of n₃, for mode υ=2.

FIG. 3 shows a variation of the decay rate, Γ, in the evanescent field versus the thickness t of the dielectric layer for the first radial mode.

FIG. 4 illustrates the radial function of the first radial mode in a microsphere with a dielectric layer of refractive index n₃=1.6 and a total radius of 100 μm.

FIG. 5 illustrates the radial function of the second radial mode in a microsphere with a dielectric layer of refractive index n₃=1.6 and a total radius of 100 μm.

FIG. 6 illustrates the adsorbate-dependent WGM response to a uniform refractive-index change in the surrounding and adsorption of small particles at low density in a microsphere coated with a 0.1 μm thick layer versus the refractive index of the layer.

FIG. 7A illustrates the fractional shift of the first radial WGM wave vector to a uniform refractive-index change in the surrounding in a coated microsphere versus layer thickness t. The layer refractive indices increments are 1.5, 1.55, 1.6, 1.65, and 1.7 in increasing order of height of the left hand peak.

FIG. 7B illustrates the fractional shift of the second radial WGM wave vector to a uniform refractive-index change in the surrounding in a coated microsphere versus layer thickness t. The layer refractive indices increments are 1.5, 1.55, 1.6, 1.65, and 1.7 in increasing order of height of the left hand peak.

FIG. 8 illustrates the fractional shift of the first three radial WGM wave vectors immersed in a medium of index n₂=1.32 plotted versus thickness t of coating layer n₃=1.7. Radial mode 1 (solid curve), radial mode 2 (dotted) and radial mode 3 (dashed-dotted) are shown overlaid.

FIG. 9 shows a sketch of the effective potential with a layer thickness (t) is much less than the radius of the microsphere (R).

FIG. 10 illustrates the theoretical enhancements for the standard sphere for each mode as a function of the layer thickness t.

FIG. 11 shows the experimentally measured fractional wavelength shift as injections proceeded.

FIG. 12 illustrates one embodiment of the present invention.

### DETAILED DESCRIPTION OF PREFERRED EMBODIMENTS

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

The present invention is directed generally to the use of whispering gallery mode (WGM) evanescent waves to detect adsorption of molecules to the surface of microsphere sensors and more particularly to the utilization of a high refractive index surface layer to increase the sensitivity thereof. The present invention examines the sensor capability of WGM in a dielectric sphere coated with a thin uniform dielectric layer of a high refractive index. The present invention provides at least three utilities of such a modified resonator for the sensing or determining the presence of substances in a medium. The first is to have an evanescent field of a different penetration depth without using a non-silica based microsphere or changing the laser wavelength. The second is to further enhance the sensitivity by drawing the optical field of WGM into the coating layer. The third is to realize the same relative shifts for WGM of different radial modes, thus eliminating ambiguities in the measurement of a refractive index change in the surrounding medium. Before examination of the sensor capabilities, the properties of WGM in the coated microsphere, especially compression of the field distribution in the radial direction, will be examined.

### Theoretical Considerations

WGM frequency-shift sensors rely on the shift of the resonance wavevector when the surrounding or a part of it experiences a change in refractive index. When a molecule or a small particle of volume Vₚ adsorbs onto the sphere, the relative electric permittivity εᵣ changes by δεᵣ in the volume. In a uniform change of refractive index in the surrounding, Vₚ is the entire exterior space. It can be shown that the shift δk of the resonance wavevector from k₀ is given by Equation 1 as follows:

$$\frac{δ k}{{k}_{0}} = - \frac{{\int }_{{V}_{p}} {δɛ}_{r} {E}_{0}^{*} \cdot {E}_{p} ⅆ r}{2 {\int }_{V} {ɛ}_{r} {E}_{0}^{*} \cdot {E}_{0} ⅆ r} \qquad Eq . 1$$

where E₀ is the electric field of WGM before the perturbation (change of εᵣ), and Eₚ is the electric field within Vₚ. The above perturbation formula indicates that the relative shift is equal to the ratio of the total excess electric energy in Vₚ (perturbation integral) to the total mode energy in the entire space V.

In the perturbation integral, E₀ is the evanescent field of WGM that decays with an increasing distance from the microsphere surface. Equation 2 indicates that the associated decay constant Γ is approximately given as
Γ≅(n₁²−n₂²)^{1/2}k₀ Eq.2
where n₁ and n₂ are the refractive indices of the microsphere and the surrounding, respectively. Its reciprocal, 1Γ, is often called the penetration depth. The spatial variation of E₀ makes WGM sensitive to the geometry of the perturbation. Below we consider briefly the geometrical sensitivity.

If the particle of volume Vₚ is isotropic, Eₚ=βE₀ with β being a coefficient that depends on the polarization direction of E₀ and the geometry of Vₚ. When Vₚ is a small particle adsorbed onto the resonator surface, E₀ refers to the field right on the surface. Therefore,
∫_{V}_{ₚ}δεᵣE₀*·Eₚdr=|E₀(r=a)|²∫_{V}_{ₚ}βδεᵣdr Eq.3
where a is the microsphere radius. If δεᵣ is uniform in Vₚ, the integral is equal to βδεᵣVₚ. When Vₚ is the entire surrounding space and δεᵣ is uniform,
∫_{V}_{ₚ}δεᵣE₀*·Eₚdr=βδεᵣ∫_{V}_{ₚ}|E₀(r)|²dr Eq. 4
The integral in Equation 4 is approximately equal to |E₀(r=a)|²2πa²/Γ. Therefore, the resonance shift depends on Γ. If Vₚ is a tenuous layer of adsorbent and thickness t_{A}, the integral is |E₀(r=a)|²(2πa²/Γ)[1−exp(−2Γt_{A})]. In Equation 2 above, we utilized the k₀ and n₂ dependence of Γ to estimate the thickness of an adsorption layer of a basic polypeptide and its volume fraction in the layer.

As previously discussed, although microsphere WGM frequency-shift sensors have demonstrated a high sensitivity in detecting adsorption of proteins and other biomolecules, the sensors, as they are, are not as quantitative as absorption spectrometers and differential refractometers are. There are two sources of problem intrinsic to the sensing scheme: polarizations and radial modes. A WGM is either in transverse electric (TE) or transverse magnetic (TM) polarization. The two polarizations have different resonance shifts, as they have different amplitudes of evanescent field relative to the amplitude of the internal field at the microsphere surface. It has been shown that the two polarizations can be selectively excited in a side-coupled microsphere-fiber pair by controlling the polarization in the optical fiber used for feeding the light and reading the transmission spectrum. The other source of problem is that different radial modes, having different penetration depths, can be excited and their shifts may be different from each other.

A more accurate expression of Γ than the one given by Equation 2 has a radial mode dependence. In a typical situation, a silica microsphere of radius 100 μm is immersed in water, and monochromatic 1.34 μm wavelength is used as the light source. The first few radial modes are believed to be observed. Higher-order modes are too broad for any meaningful sensor applications. The refractive index change estimated from the resonance shift depends on the radial mode. Below we look at the radial function closely. In a nearly perfect microsphere, the radial mode is identifiable. In an elliptic microsphere side-coupled to an optical fiber, however, presence of many non-degenerate WGM makes the identification all but impossible, although it allows one to observe resonance peaks in a narrow range of wavelength scan. Furthermore, it is difficult to selectively excite one mode order only by controlling the coupling between the microsphere and the fiber.

### WGM in a Uniform Microsphere

For simplicity, TE modes will only be considered here. Those skilled in the art will recognize the applies to TM modes as well. A spherical polar coordinate (r, θ, φ) is set up with the origin at the center of the uniform microsphere of radius a. The electric field has tangential components only. For a mode specified by the polar index l (aka mode number) and the azimuthal index m (m=−l, −l+1, . . . , l), the field E is given as

$$E = \frac{exp ( ⅈ m φ )}{kr} {S}_{l} ( r ) {X}_{lm} ( θ ) , \qquad Eq . 5$$

where k=2π/λ with λ being the wavelength of light in vacuum. The radial function Sₗ(r) satisfies

$$[ \frac{{ⅆ}^{2}}{ⅆ {r}^{2}} - \frac{l ( l + 1 )}{{r}^{2}} ] {S}_{l} = - {[ n ( r ) ]}^{2} {k}^{2} {S}_{l} , \qquad Eq . 6$$

where n(r)=n₁ at r<a and n₂ at r>a. The angular vector function Xₗₘ(θ) is given as

$${X}_{lm} ( θ ) = \frac{ⅈ m}{sin θ} {P}_{l}^{m} ( cos θ ) {\hat{e}}_{θ} - \frac{\partial }{\partial θ} {P}_{l}^{m} ( cos θ ) {\hat{e}}_{φ} , \qquad Eq . 7$$

with Pₗ^{m}(x) being the associated Legendre function, and ê_{θ} and ê₁₀₀ the unit vectors in the relevant directions. At resonance, Sₗ(r)=Aₗψₗ(n₁kr) at r<a and Bₗχₗ(n₂kr) at r>a, where a Ricatti-Bessel function ψₗ(z)≡zjₗ(z) and a Ricatti-Neumann function χₗ(z)≡znₗ(z) are defined using spherical Bessel and Neumann functions, jₗ(z) and nₗ(z), respectively. The ratio of the coefficients, Aₗ/Bₗ, is determined from the continuity of Sₗ(r) across the interface at r=a. At r>a, χₗ(n₂kr) decays nearly exponentially with a decay constant Γ=−n₂kχ′ₗ(n₂ka)/χₗ(n₂ka), where the prime denotes the derivative by the argument.

For a given l (WGM of different values of m are degenerate, meaning their resonance occurs at the same k), there are several values of size parameter ka that satisfy the continuity at resonance and have a sufficiently narrow linewidth. In the increasing order of ka, they are called the first, second, . . . orders of WGM. Each radial mode has its own Sₗ(r). The vth order has v peaks in [Sₗ(r)]².

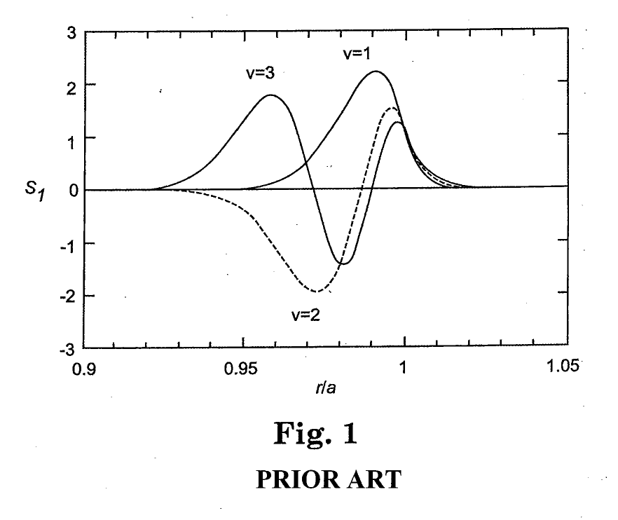

The radial functions Sₗ(r) are compared in FIG. 1 for the first three mode orders of WGM in a silica microsphere (n₁=1.452) in water (n₂=1.320). To facilitate the comparison, the functions are given the same amplitude at r=a. The latter is equivalent to normalizing Sₗ(r) by the mode energy. The mode numbers for the three functions are chosen to have a similar size parameter ka≅468.5 which would simulate a microsphere of radius a =100 μm coupled to a laser operating at λ=1.34 μm. Thus selected mode numbers are: l=666 (ka=468.52734) for v=1; l=654 (ka=468.58438) for v=2; and l=644 (ka=468.47812) for v=3. These mode numbers and the parameters n₁, n_{2,} and, a will be used in the rest of the present invention unless otherwise specified.

FIG. 1 shows an increasing penetration depth with an increasing v. The higher the mode order, the greater the fraction of mode energy in the surrounding medium. Comparison of the three curves in light of Equation 1 indicates the following: (1) When a WGM sensor detects adsorption, different radial modes will have the same shift (which is not the case for TM modes); and (2) In a uniform change of refractive index in the surrounding medium, the shift will be greater for the higher-order mode.

### WGM in a Microsphere Coated with a Dielectric Layer

To enhance the sensitivity of WGM sensors, the present invention changes the dielectric property of the microsphere resonator by coating the sphere with a thin and uniform dielectric layer of material having a high refractive index greater than that of the microsphere resonator. The dielectric layer may be coated onto the resonator by dip coating a non-crystalline polymer, for instance, or a monomer or prepolymer, followed by polymerization (curing). Alternatively, the dielectric layer coating of the microsphere resonator may be achieved by any of the following methods well known to those skilled in the art: sputtering, chemical vapor deposition, physical vapor deposition, molecular beam epitaxy, vacuum evaporation, sol-gel method or another method commonly used in optics industry for coatings; coating the resonator surface with an amorphous polymer by solvent casting; growing a polymer layer by surface-initiated polymerization; or doping the resonator with a dopant that increases the refractive index.

Two effects are expected for adding a layer to the microsphere resonator surface. One effect is the change in Γ. A dielectric layer with a refractive index greater than that of the bulk sphere will increase Γ, thus allowing the evanescent field to explore a region in the surrounding closer to the sphere surface. The other effect is the change in the amplitude of the evanescent field. Equation 3 above indicates that the resonance shift strongly depends on the field intensity at the sphere surface. Since a material of a high refractive index attracts light, a layer made of such materials will enhance the amplitude of the field at the surface and therefore also the amplitude of the evanescent field. The present invention allows the sensitivity of WGM frequency-shift sensors to be enhanced by fine-tuning the refractive index and the layer thickness. The present invention further allows for radial mode-independent resonance shifts, thereby eliminating ambiguity of the WGM sensor as a refractive index detector. An improvement may also be seen under the teachings of the present invention on the already small ambiguity of the sensor as adsorption detector in TM modes. Preparation of microspheres with different field distributions and penetration depths may lead to many other different applications of the WGM sensor, such as sensing refractive index profiles and non-aqueous media. Next, let us consider WGM in a microsphere coated with a layer.

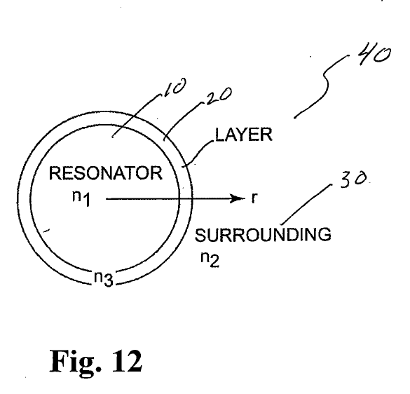

Let us now examine the effects of adding a thin layer of refractive index n₃ and thickness t to the existing microsphere of refractive index n₁, the microsphere existing in a surrounding environment of refractive index n₂. One embodiment of such a device is illustrated in FIG. 12. For convenience, a is used for the total radius of the coated microsphere and for purposes of the following, a is held unchanged. In effect, the refractive index is changed in the surface region of depth t:

$$n ( r ) = \{ \begin{matrix}{n}_{1 } & ( r < a - t ) \\ {n}_{3} & ( a - t < r < a ) \\ {n}_{2} & ( a < r )\end{matrix} \qquad Eq . 8$$

The radial function Sₗ(r) within the layer is expressed as a linear combination of two independent solutions of Eq. 6 with n(r)=n₃:

$${S}_{l} ( r ) = \{ \begin{matrix}{A}_{l} {ψ}_{l} ( {n}_{1} kr ) & ( r < a - t ) \\ {C}_{l} {ψ}_{l} ( {n}_{3} kr ) + {D}_{l} {χ}_{l} ( {n}_{3} kr ) & ( a - t < r < a ) \\ {B}_{l} {χ}_{l} ( {n}_{2} kr ) & ( a < r )\end{matrix} \qquad Eq . 9$$

where Aₗ, Bₗ, Cₗ, and Dₗ are coefficients.

The boundary conditions at r=a−t and r=a require that Sₗ(r) and S′ₗ(r) be continuous across these interfaces, which leads to

$$\begin{matrix}\frac{{n}_{2}}{{n}_{3}} \frac{{χ}_{l}^{′} ( {n}_{2} ka )}{{χ}_{l} ( {n}_{2} ka )} = \frac{( {C}_{l} / {D}_{l} ) {ψ}_{l}^{′} ( {n}_{3} ka ) + {χ}_{l}^{′} ( {n}_{3} ka )}{( {C}_{l} / {D}_{l} ) {ψ}_{l} ( {n}_{3} ka ) + {χ}_{l} ( {n}_{3} ka )} & Eq . 10 \\ where & \\ \frac{{C}_{l}}{{D}_{l}} = \frac{{n}_{3} {ψ}_{l} ( {z}_{1} ) {χ}_{l}^{′} ( {z}_{3} ) - {n}_{1} {ψ}_{l}^{′} ( {z}_{1} ) {χ}_{l} ( {z}_{3} )}{- {n}_{3} {ψ}_{l} ( {z}_{1} ) {ψ}_{l}^{′} ( {z}_{3} ) + {n}_{1} {ψ}_{l}^{′} ( {z}_{1} ) {ψ}_{l} ( {z}_{3} )} & Eq . 11\end{matrix}$$

with z₁=n₁k(a−t) and Z₃=n₁k(a−t). The above two equations give k=k₀ at resonance. The linewidth w for the coated microsphere is defined as

$$w = \frac{2}{{( ⅆ γ / ⅆ k )}_{k = {k}_{0}}} \qquad Eq . 12$$

where Bₗ[χₗ(n₂kr)+γψₗ(n₂kr)] gives Sₗ(r) at r>a for k off resonance. At k=k₀, γ=0.

For a given layer thickness, the resonance moves to a longer wavelength with an increasing n₃, which is due to a shift of the photonic field toward a greater radial distance from the microsphere center and also due to a greater portion of the field residing in the high-refractive index layer. The decrease of k and the shift of Sₗ(r) occur for all of the three radial modes. As Sₗ(r) moves outward, the evanescent field intensifies, most seriously for the first radial mode. The field intensifies while the resonance line rather narrows, because the increase in n₃ causes Γ to increase, and thus penetration becomes shallower. Adding a layer of a high refractive index exposes WGM more to the surrounding, but without sacrificing the narrow linewidth. In contrast, a uniform microsphere with a lower refractive index exposes a greater portion of WGM to the surrounding, but it accompanies a line broadening.

Intrinsic loss of WGM in a perfectly uniform microsphere is negligible for the first two radial modes. The linewidth w of the third radial mode is already close to or exceeds the experimentally obtained values. The linewidth of the fourth radial mode (t=0) is 6.7×10⁻⁵ μm⁻¹, which is too broad for use in a WGM sensor. Therefore, we consider the first three radial modes only.

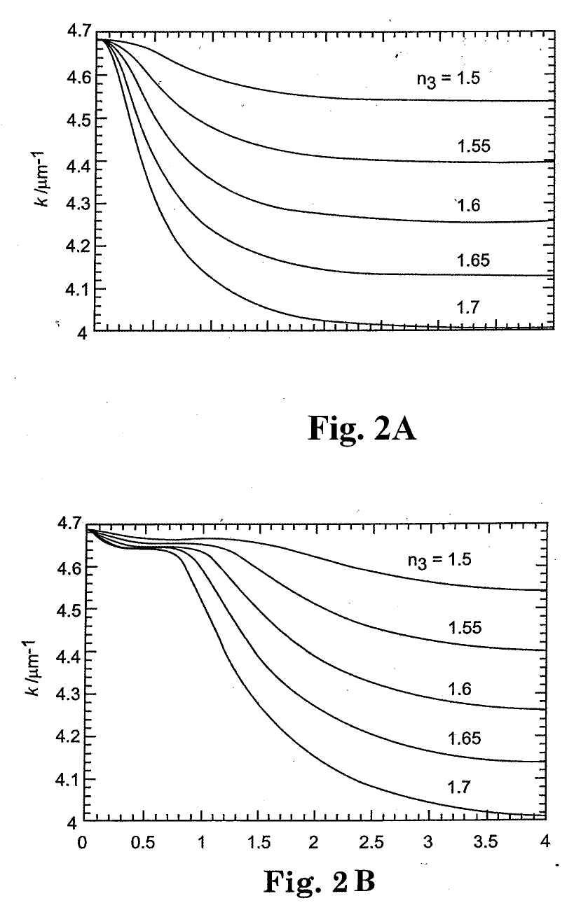

Certain embodiments of the present invention comprise changing the layer thickness t without changing the overall sphere radius a. FIGS. 2A (v=1) and 2B (v=2) present plots of k at resonance as a function of t for different values of n₃. As the coating becomes thicker, the resonance shows a red shift, since the photonic field is drawn more strongly to the microsphere surface. The change of resonant k with increasing t is highly nonlinear. A perturbation treatment of WGM resonance for a small relative permittivity increment, similar to Equation 1, but applied to the interior of the sphere, gives −δk/k₀=(t/a)(n₃²−n₁²)/(n₁²−n₂²). This estimate is effective for thin layers only. The deviation is already abound 40% at t=0.1 μm (v=1, n₃=1.5). In FIG. 2A, k approaches a constant for each n₃ with an increasing t. The constant is the resonant k in a microsphere with a uniform refractive index n₃ immersed in a medium of n₂, and is approximately equal to l/(n₃a).

In FIG. 2B, k changes in two steps and the approach to an asymptote requires a thicker coating compared with v=1. The change in the first step is a lot smaller than the change in the second step. The third-order mode changes k in three steps, and the approach to an asymptote requires an even thicker coating.

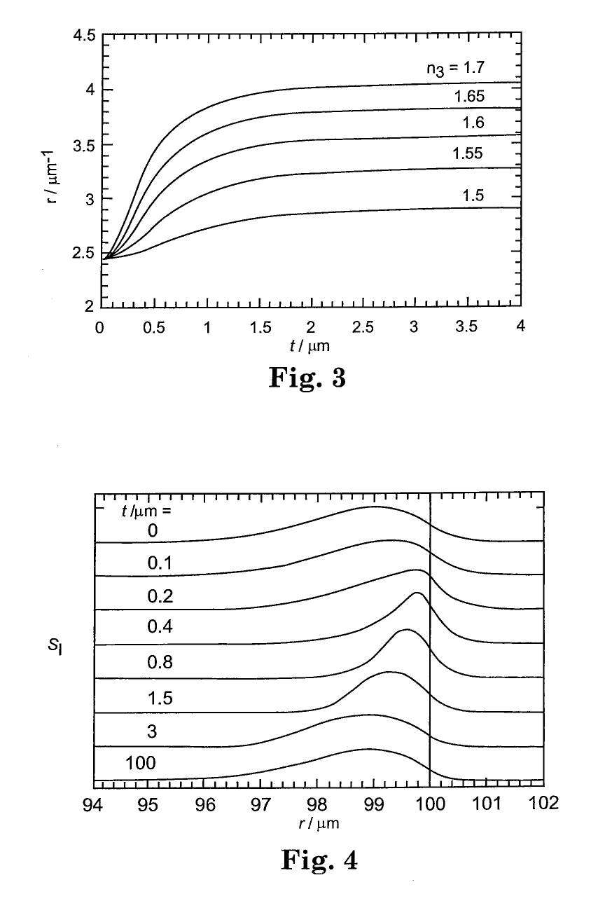

When the resonance shifts with an increasing layer thickness, the decay constant of the evanescent field increases, as the microsphere is increasingly dominated by the high-refractive index layer. FIG. 3 shows a plot of Γ for v=1. At t=2,λ/n₁, Γ reaches 99% of the value for a simple sphere of n₃.

The plots of Sₗ(r) reveal the nature of WGM, which is shown in FIG. 4 for v=1, n₃=1.6 and different values of t from 0 to 100 μm=a. Each curve is normalized by the mode energy. With an increasing layer thickness, Sₗ(r) becomes more skewed outward with a concomitant narrowing in the width. Once focused in the 1 μm region from the surface, Sₗ(r) barely changes for 0.6 μm<t<1 μm. The thin high-refractive index layer causes radial compression of Sₗ(r). A further increase in the thickness brings back the photonic field inward. When the layer is sufficiently thick, the field is located more inward compared with the microsphere without a layer, as the higher microsphere-surrounding contrast forces a stronger confinement of light.

Mathematically, the narrowing draws on the property of Ricatti-Bessel functions. When z>>l, ψₗ(z)≅sin(z−lπ/2) and χₗ(z)≅−cos(z−lπ/2). In the surrounding medium, Sₗ(r) ˜χₗ(n₂kr) slowly approaches its asymptote with an increasing r. In the approach, the period of oscillation decreases to λ/n₂. Within a microsphere without the layer, z=n₁kr is close to l. At around this value of z, ψₗ(z) changes rather slowly; see FIG. 1. With the layer present, its high refractive index lets ψₗ(z) and χₗ(z) have greater values of z, which is n₃kr, in the layer. Therefore, ψₗ(z) and χₗ(z) can change rapidly.

A look at the change of the peak position with an increasing t reveals an interesting phenomenon. The peak moves outward until it reaches the interface to the growing layer. With a further increase in t, the peak starts to move back. When n₃ is sufficiently high, the peak position is close to the midpoint of the layer until t reaches about 1 μm. These movements are observed even if we hold the radius of the silica microsphere unchanged and grow a layer of a high refractive index.

Similar transitions in Sₗ(r) with an increasing t are observed for layers of different n₃. At n₃=1.5, the narrowing is rather modest, and the peak does not move as much as in FIG. 3. At n₃=1.7, the narrowing and the shift of the peak are more pronounced. The transition occurs for thinner layers.

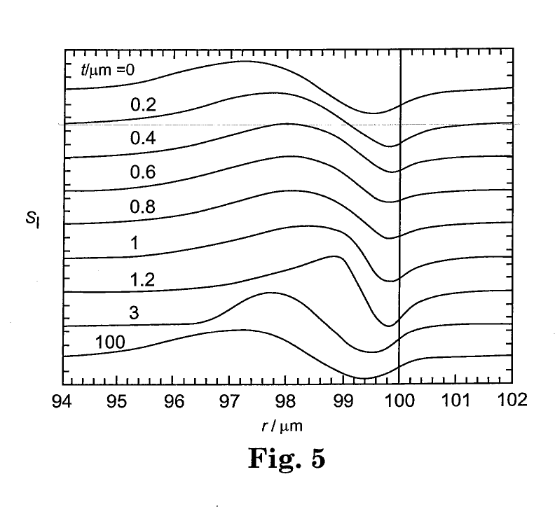

FIG. 2B indicates a two-stage transition in the second radial mode of WGM with an increasing t. We examine its Sₗ(r) for n₃=1.6 in FIG. 5. Recall the plot of k at n₃=1.6 was stagnant from t=0.5 to 0.8 μm in FIG. 2(b). In FIG. 5, the first change in the peak shape with an increasing t occurs primarily in the outermost peak which is negative. As t increases to 0.2 μm, the peak moves outward without changing its depth. From t=0.2 to 0.5 μm, the peak does not change its position, but becomes shallower. The main positive peak moves outward as t increases to 0.5 μm. From 0.5 to 0.8 μm, Sₗ(r) is nearly stationary, consistent with the stationary k. With a further increase of t up to ca. 1 μm, the negative peak deepens and moves outward. Starting at around 1.2 μm, both peaks start to move back inward, as the coated sphere becomes close to a simple sphere of a high refractive index. Both peaks are the narrowest at around t=1.5 μm. The widths of the two narrow peaks are close to each other, and are close to the peak width of the surface mode for v=1. With two peaks in [Sₗ(r)]², the attraction of the field by the high-refractive index layer occurs differently for the two peaks at different values of t. For the inner peak to move near the surface requires a thicker layer. When n₃ is higher than 1.6, all the transitions occur for thinner layers.

The changes in Sₗ(r) of the third radial mode follow what is expected from those of the second mode. Since [Sₗ(r)]² has now three peaks with the highest peak being the innermost, the first two transitions with an increasing t are consumed to lower the heights of the first two peaks. All the while, the main peak keeps moving outward. The narrowest peaks are seen at around t=2.4 μm for n₃=1.6, common to the three peaks.

Although the above calculations have focused on analyzing the condition wherein the layer of high refractive index has a constant refractive index throughout thickness t (see equation 8, term n₃), the present invention is not limited to this condition.

In an alternative embodiment, the high refractive index layer may consist of a series of two or more discrete high refractive index materials deposited one layer at a time, i.e., one on top of the other - - - e.g., n₃ₐ, n_{3b}, n_{3c}, etc., utilizing the notation of Equation 8, all of which being of a greater refractive index than the microsphere core. Depositing films in this manner can be accomplished via vacuum deposition, sputtering, or additional techniques known to those skilled in the art of thin film deposition. In another alternative embodiment, the high refractive index layer may consist of a continuously varying index throughout thickness t. In yet another embodiment of the present invention, the high refractive index material, i.e., the dielectric layer, may consist of a birefringent material with sufficiently differing refractive indices (birefringence) to match and/or equalize the sensitivities of the microsphere resonator's radial TE and TM modes. In addition, such dielectric layer may comprise birefringent material of sufficient birefringence to match and/or equalize the evanescent penetration depth of the resonator's TE and TM radial modes.

Similarly, the above calculations have focused on the case wherein the high refractive index material has been deposited and/or coated on a silica microsphere surface. The present invention also contemplates the use of alternative materials for the microspheres, including but not limited to, sapphire, borosilicate glasses, and calcium fluoride. Alternative embodiments of the present invention contemplate the use of geometrically symmetrical structures such as spheroids, discs, rings, toroids, and in general, surfaces of revolution as acceptable geometries for overcoating with high RI materials. Those skilled in the art will readily recognize structures that are equivalent, each of which is within the scope of the present invention. Also, the above calculations have focused on the case wherein the high refractive index material has been immersed in water. The present invention also contemplates the case where resonator, be it a microsphere or the alternative embodiments described above, may be immersed in any biological fluid including for example human blood, plasma, urine, interstitial fluid, or tears, amongst others. Also, the resonator may be immersed in non-biological media such as alcohol, organic solvents, or any chemical that may pose an environmental hazard.

Similarly, the above calculations have focused on the case wherein the sensing of adsorbed molecules on the surface of the resonator is accomplished via an induced frequency shift in the optical source wavelength. The present invention also contemplates the use of absorption and Raman spectroscopy techniques to sense the arrival of adsorbed molecules.

### Sensor Responses

Let us now turn to the resonance shifts in a microsphere coated with a high refractive index dielectric layer according to one embodiment of the present invention in response to two types of perturbation: a small uniform change of refractive index in the surrounding and adsorption of small particles onto the microsphere surface at a low density.

For E₀=E given by Equation 5, the angular part is isolated in the mode energy integral:
∫_{V}εᵣE₀*·E₀dr=Wk⁻²∫₀^{∞}[n(r)Sₗ(r)]²dr Eq. 13
where W is the integral of |Xₗₘ|² over the entire solid angle, and k is used for k₀. For Sₗ(r) given by Equation 9, the radial integral consists of three parts:
∫₀^{∞}[n(r)Sₗ(r)]²dr=n₁²I₁+n₃²I₃+n₂²I₂ Eq. 14
where
I₁≡∫₀^{a-t}A₁²[ψₗ(n₁kr)]²dr Eq. 15a
I₃=∫ₐ₋ₜ^{a}[Cₗψₗ(n₃kr)+Dₗχₗ(n₃kr)]²dr Eq. 15b
I₂≡∫ₐ^{∞}Bₗ²[χₗ(n₂kr)]²dr Eq. 15c
It can be shown that I₁ and I₂ are given by;
I₁=(Aₗ²/n₁k)Ψₗ(n₁k(a−t) Eq. 16a
I₂=(Bₗ²/n₂k)Xₗ(n₂ka) Eq. 16b
where
Ψₗ(z)≡∫₀^{z}[ψₗ(x)]²dx=−{−zψ′ₗ²+[l(l+1)/z−z]ψₗ²+ψₗψ′ₗ}/2 Eq. 17a
Xₗ(z)≡∫_{z}^{∞}[χₗ(x)]²dx={−zχ′ₗ²+[l(l+1)/z−z]χₗ²+χₗχ′ₗ}/2 Eq. 17b

The I₃ is calculated as
I₃=I₃ₐ+I_{3b}+I_{3c} Eq. 18
where
I₃ₐ≡C₁²∫ₐ₋ₜ^{a}[ψₗ(n₃kr)]²dr=(Cₗ²/n₃k)[Ψₗ(n₃ka)−Ψₗ(n₃k(a−t))] Eq. 19a
I_{3b}≡2CₗDₗ∫ₐ₋ₜ^{a}ψₗ(n₃kr) χₗ(n₃kr) dr=(2CₗDₗ/n₃k) [Ξₗ(n₃ka)−Ξₗ(n₃k(a−t))]Eq. 19b
I_{3c}≡Dₗ²∫ₐ₋ₜ^{a}[χₗ(n₃kr)]²dr=(Dₗ²/n₃k)[Xₗ(n₃k(a−t))−Xₗ(n₃ka)] Eq. 19c
with Equation 20 shown below,
Ξₗ(z)≡∫ψₗ(z)χₗ(z)dz=const.+{[z−l(l+1)/z]ψₗχₗ−(ψₗχ′ₗ+ψ′ₗχₗ)/2+zχ′ₗψ′ₗ}/2 Eq. 20
When the relative electric permittivity of the surrounding changes uniformly from n₂² to n₂²+δ(n²), where δ(n²)<<1, Eₚ=E₀ in the first-order perturbation (TE). Then, the perturbation integral is
∫_{V}_{ₚ}δεᵣE₀*·Eₚdr=Wk⁻²δ(n²)I₂ Eq. 21
We define a response G_{RI} as the fractional shift of the resonance wavevector relative to the permittivity increment:

$${G}_{RI} ≡ \frac{- δ k / {k}_{0}}{δ ( {n}^{2} )} = \frac{{I}_{2}}{2 ( {n}_{1}^{2} {I}_{1} + {n}_{3}^{2} {I}_{3} + {n}_{2}^{2} {I}_{2} )} \qquad Eq . 22$$

The sensitivity of the WGM shift sensor to the refractive index change depends solely on the property of WGM prior to the change.

For adsorption of small particles at a low density, Eₚ=[3n₂²/(nₚ²+2n₂²)]E₀, where nₚ is the refractive index of the particle. For a particle adsorbed at (a, θ, φ), the perturbation integral is

$${\int }_{{V}_{p}} {δɛ}_{r} {E}_{0}^{*} \cdot {E}_{p} ⅆ r = \frac{3 {n}_{2}^{2} ( {n}_{p}^{2} - {n}_{2}^{2} )}{{n}_{p}^{2} + 2 {n}_{2}^{2}} {V}_{p} {\vert {E}_{0} ( a , θ , ϕ ) \vert}^{2} \qquad Eq . 23$$

Assuming a uniform distribution of particles on the surface, the total energy change in Nₚ particles is

$$\sum {\int }_{{V}_{p}} {δɛ}_{r} {E}_{0}^{*} \cdot {E}_{p} ⅆ r = \frac{3 {n}_{2}^{2} ( {n}_{p}^{2} - {n}_{2}^{2} )}{{n}_{p}^{2} + 2 {n}_{2}^{2}} {V}_{p} \frac{{N}_{p}}{4 π} \int {\vert {E}_{0} ( a , Ω ) \vert}^{2} ⅆ Ω \qquad Eq . 24$$

where Ω=(θ, φ). The angular integral is calculated as W(ka)⁻²[Sₗ(a)]². We isolate the adsorbate-dependent factor from the fractional shift and introduce a response G_{ads} defined as

$${G}_{ads} ≡ - {\frac{δ k}{{k}_{0}} [ \frac{3 {n}_{2}^{2} ( {n}_{p}^{2} - {n}_{2}^{2} )}{{n}_{p}^{2} + 2 {n}_{2}^{2}} \frac{{V}_{p} {N}_{p}}{4 π {a}^{3}} ]}^{- 1} = \frac{{a [ {S}_{l} ( a ) ]}^{2}}{2 ( {n}_{1}^{2} {I}_{1} + {n}_{3}^{2} {I}_{3} + {n}_{2}^{2} {I}_{2} )} \qquad Eq . 25$$

when t=0, G_{ads}=1(n₁²−n₂²) for all values of v.

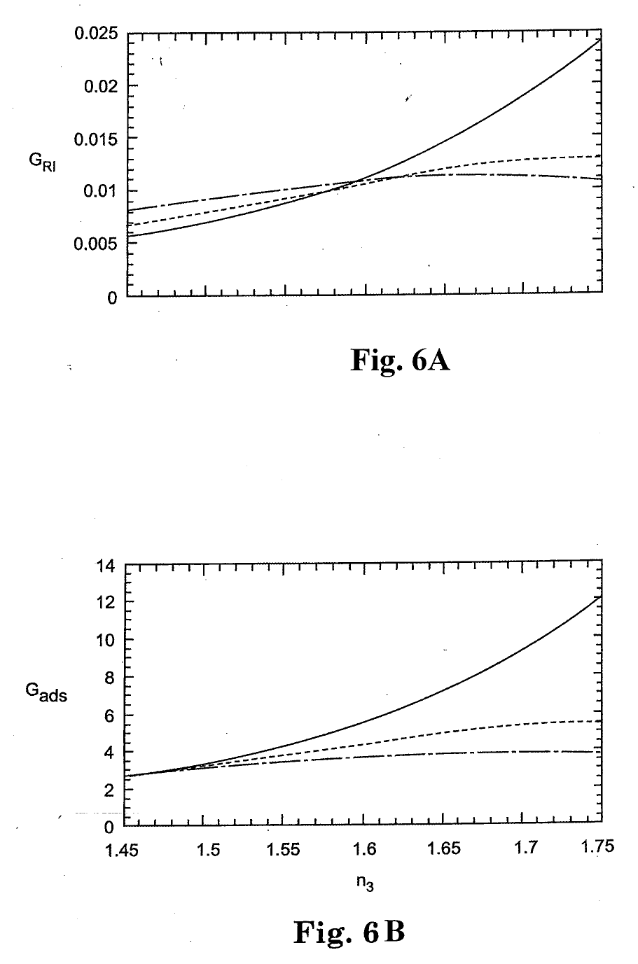

The two responses, G_{RI} and G_{ads}, are readily evaluated once Sₗ(r) is determined as is illustrated in FIGS. 6A and 6B which provide plots of G_{RI} and G_{ads}, respectively, as a function of n₃ for the thin layer of t=0.1 μm and the three radial modes. The change of G_{ads} in FIG. 6B reflects the change of Sₗ(a), the field right on the surface. For the first radial mode, G_{ads} simply increases as the higher refractive index exposes a stronger evanescent field. At n₃=1.75, the sensitivity is 4.1 times as high as the one without the layer. The increase in G_{ads} with an increasing n₃ is a lot smaller and a peaking is seen for the second radial mode, and even more so for the third radial mode. For these higher-order modes, the increase in [Sₗ(a)]² is modest, as the high-refractive index layer induces a more pronounced effect on the inner major peak in [Sₗ(r)]² rather than on the outermost peak.

The changes in G_{RI} shown in FIG. 6A represent the combined effect of [Sₗ(a)]² and Γ. The increases in G_{RI} with an increasing n₃ are not as much as those in G_{ads}, as the concomitant increase of Γ has an effect of decreasing I₂. Note that G_{RI} for the three radial modes are different for the plain silica microsphere. At n₃=1.452=n₁, G_{RI} of the third radial mode is 45% larger than G_{RI} of the first mode. The spread of G_{RI} among the three radial modes shrinks with an increasing n₃. At n₃=1.573, the first two radial modes have a matched sensitivity. If only the first two radial modes are excited for the measurement, then coating a silica microsphere with a 0.1 μm thick layer of refractive index 1.573 will eliminate ambiguities in the estimate of the refractive index change. Another way to eliminate ambiguities may be to let different radial modes have vastly different shifts so that the mode order can be identified for each peak in the resonance spectrum. The latter may be accomplished by adjusting the refractive index and thickness of the layer.

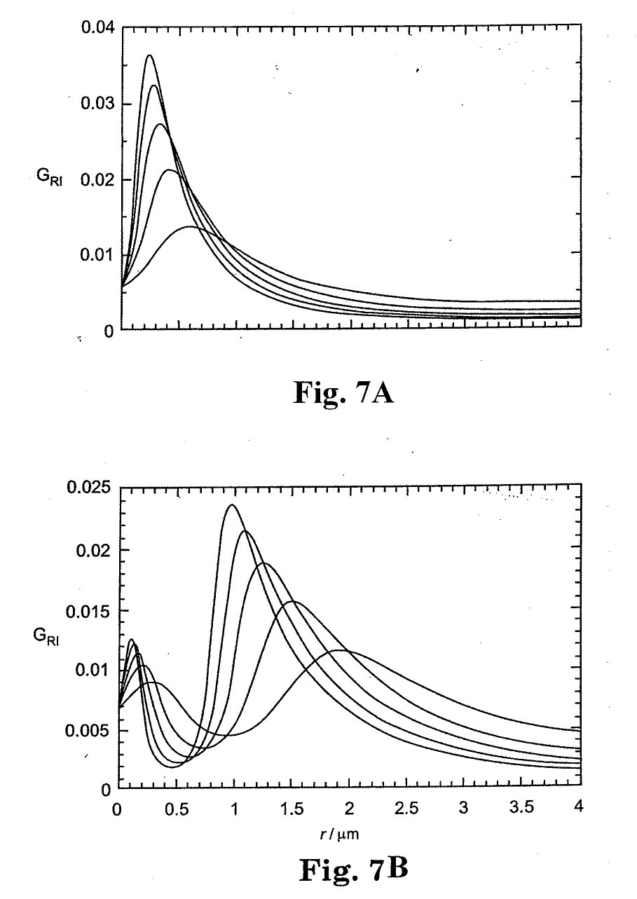

FIGS. 7A and 7B illustrate how G_{RI} changes with t. FIGS. 7A and 7B show G_{RI} of the first and second radial modes, respectively, as a function of t for five values of n₃ from 1.5 to 1.7. Each curve in FIG. 7A is consistent with the change in Sₗ(r) that shows an outward shift, followed by a retreat, with an increasing t. The peak of the curve shifts to a smaller t with an increasing n₃. At the peak (t=0.33 μm), the sensitivity of a microsphere coated with n₃=1.6 is 4.8 times as high as that of a plain WGM sensor.

FIG. 7B illustrates that the enhancement of the sensitivity takes an oscillatory path for the second radial mode. The path is consistent with the change in Sₗ(r) shown in FIG. 5. The sensitivity enhancement is not as large as the one for v=1. In the third radial mode, each curve of G_{RI} has three peaks. The enhancement of G_{RI} is even less.

Those skilled in the art will recognize that the plots of G_{ads} are similar to those of G_{RI}; the enhancement by the coating is slightly greater. At the peak (t=0.36 μm), the sensitivity of a microsphere coated with n₃=1.6 is 5.5 times as high as that of the plain WGM sensor. The plots of G_{ads} are essentially the derivatives of the curves in FIG. 2. Forming an adsorption layer amounts to increasing t. This relationship is illustrated in FIGS. 2 and 7, although the latter is affected by the changing Γ.

The different enhancement effects on the three radial modes may lead to matching of G_{RI} among the modes using certain embodiments of the present invention. Perfect matching is not possible for the silica microsphere with a uniform layer. The closest matching occurs at n₃=1.61 and t=0.08 μm. At this condition, G_{RI} is matched for the first and second radial modes, and G_{RI} of the third radial mode is less than 7% different from the G_{RI} of the other modes. If a microsphere material of n₁ greater than the refractive index of silica is employed under the present invention, the G_{RI} of the three modes at t=0 will be brought closer to each other, which thus facilitating the matching.

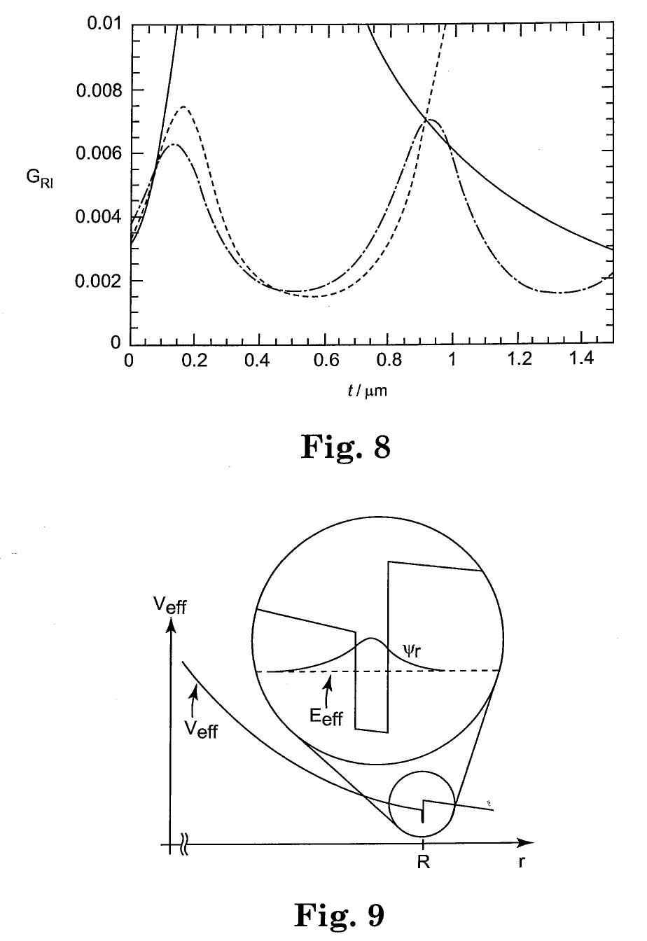

An example of such three-way matching is shown in FIG. 8. The G_{RI} for the three radial modes are plotted as a function of t. For this figure, n₁=1.51, n₂=1.32, and n₃=1.7. Different mode numbers l, 692 (v=1), 680 (v=2), and 669 (v=3), were used to keep the resonance wavelength at around 1.34 μm (t=0). It may appear that the three curves coincide at two points, but the coincidence at around t=0.07 μm is less desirable than the coincidence at t=0.906 μm is. At the second coincidence, G_{RI} is 2.2 times as large as the value for the first radial mode in a plain microsphere of n₁=1.51. This example demonstrates that it is possible to have the same resonance shifts for different radial modes using various embodiments of the present invention. It will be possible to find a coincidence point for a medium of a different n₂ (other than that of water) by adjusting n₁, n₃, and t.

In the analysis above, we assumed a perfect sphere. In practice, however, the microsphere has a small but finite ellipticity, which causes the degenerate 2l+1 modes to split. To be precise, the effect of the high-refractive index layer on the shift will be different for each split mode. However, the difference will be small for the modes excited by the side coupling with the fiber at the equator.

The possibility that a microsphere sensor can have its sensitivity improved may be demonstrated experimentally in solution. For the first order radial WGM in a silica microsphere 200 μm in radius (in water) our electromagnetic calculations indicate that 0.6% of the modal energy resides in the evanescent field at 1310 nm. This is in stark contrast to silica nano-fibers 500 nm in diameter where more than 50% of the energy is evanescent at the same wavelength. So enhancement may be possible if a sub-λ layer of relatively high refractive index can be formed around a homogeneous silica sphere. Although a nano-layer is not a nano-fiber, and one must figure out how to couple to its first order mode, a detailed electromagnetic analysis is consistent with this enhancement hypothesis.

Those skilled in the art will readily understand the effect of a high index sub-λ layer on a WGM from a quantum analog. With the field of a TE mode expressed as a dimensionless angular momentum operating on a scalar wave function, \hat{L}ψ, the vector wave equation reduces to a scalar equation having a Schrödinger form (with 2 m/ [symbol] ²=1). Within this quantum analog the effective energy is the square of the free space wave vector, E_{eff}=k₀², and the effective potential is V_{eff}=k₀²[1−n(r)²]+l(l+1)/r², where n(r) is the radial refractive index profile and l is the angular momentum quantum number. As a standard for all experimental work and calculations described below, the excitation wavelength corresponds to λ=1310 nm, a fluorine doped silica microsphere with R=200 μm is selected as our substrate (n₁=1.43), polystyrene (PS, n₃=1.57) of thickness t is the chosen coating material, and water (n₂=1.32) as the base external medium. The dielectric layer is not limited to polystyrene. Those skilled in the art will readily recognize similar and/or equivalent high-refractive index materials that may comprise the dielectric layer such as, inter alia, zirconia.

### Experimental Results

The enhancement theory outlined above was tested on a fluorine doped silica microsphere (FSM, R˜200 μm) having a Polystyrene (PS) layer. Fluorine doped silica was chosen to have the possibility of phase matching the 1^{st} order mode to a tapered silica fiber. The layered sphere was formed through a multi-step process. First, the surface of the FSM was modified so that PS would adhere to it. This was accomplished by reacting silanol groups on the silica surface with a silane agent [diphenylmethylchlorosilane (DPMCS)]. Next, the sphere was dip-coated in a PS solution. PS naturally attaches to the phenyl groups on the DPMCS. Finally, the surface was annealed beyond the PS glass transition temperature in order to relieve internal stress and remove excess solvent (xylenes). Atomic Force Microscope (AFM) scans revealed that the rms roughness of the PS surface is comparable to that of bare silica. The layer thickness on a given sphere was determined by scratching the PS layer down to the silica substrate, and measuring the step height using AFM. By a slight modification in the coating process, spheres having layer thicknesses between 195 and 350 nm were generated.

FIG. 9 shows a sketch of V_{eff} for this experimental system with the layer thickness t<<R. This potential is characterized by a narrow asymmetric well that opens into a “bowl” above the well. For the chosen parameters (t=500 nm) the first order transverse electric mode TE¹₁₃₅₄ (subscript=l) is clearly trapped by the potential well. More notably, for this “layer mode” the fraction of energy contained within the evanescent field beyond the layer is calculated to be as much as 7× the fraction in the evanescent field outside a homogeneous silica sphere of the same radius. This enhancement EN_{RI} is expected for the resonance shift associated with chemical sensing due to changing refractive index in the surrounding solution.

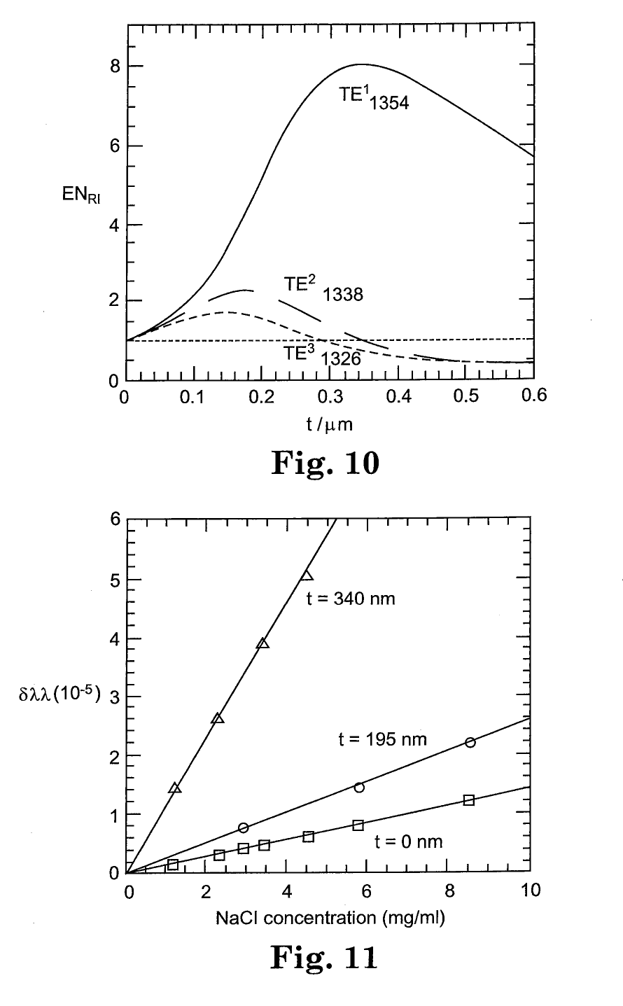

EN_{RI} may be calculated numerically based on the exact use of Maxwell's equations as applied to continuous media. For our standard sphere a number of TE modes having different orders resonate nearest to 1310 nm. Of these, the lowest order modes are TE¹₁₃₅₄, TE²₁₃₃₈, TE³₁₃₂₆. FIG. 10 shows the theoretical enhancements for our standard sphere for each of these modes as a function of the layer thickness t. Clearly the most pronounced effect occurs for the 1^{st} order mode for t=350 nm where the enhancement is 8×. In addition intrinsic losses from this mode due to leakage are extremely small, since it is buried deep in the well and has a very low tunneling probability to free space modes.

The present experimental approach utilized a distributed feedback laser source wherein light was coupled evanescently into a microsphere from a tapered fiber with both immersed in an aqueous solution. Resonances are detected from dips in the transmitted light through the fiber as a DFB laser (˜1310 nm) is current tuned. The fiber was tapered adiabatically with waist diameter of 1.5 μm. The key to exciting the 1^{st} order mode of the layered sphere is matching its effective index n_{eff} to that of the fiber mode. The fiber mode index increases with the fiber diameter, and therefore acts as a tuning element by sliding the sphere along it. The 1^{st} order mode has a considerably larger n_{eff} than the 2^{nd} or 3^{rd} order mode, since it has more of its wave function inside the high index layer. This elevation in n_{eff} due to layering places the 1^{st} order mode of a coated silica sphere beyond the phase matching criteria for all reasonable fiber diameters (<5μm). This problem is overcome by lowering the sphere's core refractive index by fluorine doping; wherein the refractive index is lowered by 0.02. Our calculations indicate that exciting a 1^{st} order mode in a layered sphere with t=300 nm, requires a much thicker fiber having a diameter of 3200 nm. Second and 3^{rd} order modes are best coupled to using fiber diameters near 2000 nm. Although a distributed feedback (DFB) laser was utilized in the present experimental set-up, the present invention is not limited exclusively to this type of optical source. Alternative embodiments of the present invention contemplate the use of laser sources such as fiber lasers, tunable lasers, or any equivalent laser or fiber optic device as are well known to those skilled in the art and which may generate the appropriate wavelength, polarization state, coherence length, etc. The optical source is in optical communication with the microsphere resonator.

The experimental cell consisted of a disposable cuvette cut down to a 1.1 cm height (volume 1.1 ml) with a tapered fiber drawn horizontally through 1 mm slots on either side. A microsphere (˜200 μm in radius) at the end of a stem was inserted from the top of the cuvette and brought in contact with the fiber, as in our previous work. Initially the sample cell was filled with 1000 μl of deionized water. The transmission spectrum upon first contact usually consisted of several dips having various widths. By sliding the sphere along the fiber we found that at certain fiber coupling diameters the spectrum resolved into periodic dips of constant width.

The refractive index of the environs was then elevated minutely by adding NaCl to experimentally test the sensitivity enhancement of the present invention. Either 10 μl of a 5 M or 2 M NaCl solution was added several times. A magnetic stirrer within the cell homogenized the solution. FIG. 11 shows the fractional wavelength shift that resulted by tracking several characteristic resonances as the injections proceeded. In comparison with a bare sphere (lowest line), FIG. 11 shows a clear enhancement for the data taken on the layered spheres. The largest measured enhancement of 8.4× was on a sphere with R=183 μm and t=340 nm (top line). The resonances giving rise to this effect were selected with a fiber contact diameter near 3000 nm and have a Q approaching 3×10⁵. Also shown is the data for the smallest measured enhancement [1.5×], which happened to be taken on the sphere having the smallest measured layer thickness t=195 nm (middle line).

The results displayed in FIG. 11 are consistent with the theoretical predictions in FIG. 10 and the associated description. Clearly the 8.4 fold enhancement for t=340 nm may be connected with the stimulation of the 1^{st} order “layer mode”, whereas the smaller enhancement of 1.5× for t=195 nm is likely associated with a 3^{rd} order mode. Thus, the present invention provides for the channeling of energy into a sub-λ layer, wherein this phenomena leads to a substantial increase in shift sensitivity of the WGM sensor. Using previously known techniques increasing the sensitivity of a silica sphere by a factor of 8.4 could only be realized by reducing its size by the same factor; from R=183 μm to R=22 μm. However, the Q of such a sphere at a wavelength of 1.3 μm is limited by radiation leakage to less than 10⁴. The present invention's result already has a Q of 3×10⁵.

The enhancement demonstrated in this correspondence has merely scratched the surface with respect to the possibilities. Only approximately 5% of the modal energy is currently evanescent under the previous examples using the present invention. Calculations indicate that an enhancement of over 50× can be anticipated by lowering the refractive index of the core to that of water. Fluorine doped polymers having the refractive index of water and the robustness of plexiglass are then another choice of material for the microsphere resonator.

FIG. 12 illustrates one embodiment of the present invention. The microsphere resonator 10 is illustrated as a spheroid, though other embodiments are possible as will be understood by those skilled in the art. For example and without limitation, symmetrical geometry structures may be utilized including, inter alia, discs, rings, toroids and the like. Each of these embodiments is within the scope of the present invention.

A dielectric layer 20 is illustrated surrounding the resonator, the layered resonator illustrated within a surrounding environment 30. The resonator 10 further comprises an index of refraction n₁, the dielectric layer 20 comprising an index of refraction n₃ and the surrounding environment comprising an index of refraction n₂. According to the invention, n₃ is greater or higher than n₁. The dielectric layer 20 may be of uniform thickness or, alternatively, may be of non-uniform thickness. The dielectric layer 20 may further comprise a uniform refractive index, e.g., n₃, or, alternatively, may comprise a continuously varying refractive index over the thickness of the layer. As discussed herein, the refraction index n₃ or indices in the case of a varying refractive index, is greater than n₁.

The optical source is not shown, though those skilled in the art will readily understand and recognize optimal placement and the requirement for optical communication between the optical source and the resonator 10. As discussed above, possible optical sources comprise distributed feedback (DFB) lasers, fiber lasers, tunable lasers, or any equivalent laser or fiber optic device.

As evidenced by the discussion above, attaching such a high-refractive dielectric layer 20 onto a plain transparent microsphere resonator 10 draws the electric field of the whispering gallery mode nearer to the resonator surface, thus intensifying the evanescent field that polarizes the adsorbed particles and the surrounding environmental medium. In this manner sensitivity of a whispering gallery mode photonic sensor is enhanced.

The invention may comprise at least one dielectric layer 20 described above. At least two dielectric layers (not shown), an inner layer surrounding the microsphere and an outer layer surrounding the inner layer, may be used to further enhance the sensitivity of the sensor 40. In this embodiment, the outer layer and the inner layer may have refractive indices that differ from each other. Using this embodiment of the present invention thus allows construction of concentration profiles in the immediate vicinity of the resonator surface or distinguishing adsorption from uniform refractive index change in the surroundings. Similarly, an additional dielectric layer may be employed surrounding the outer layer to further enhance the sensitivity and utility of the device. Those skilled in the art will recognize that a plurality of such concentric dielectric layers may be used in the present invention.

An alternative embodiment of the present invention comprises a tunable laser as the at least one optical source (not shown) and further comprises selecting discrete wavelengths and communicating the discrete wavelengths to the at least one resonator to allow construction of concentration profiles in the immediate vicinity of the resonator surface. Alternatively, the tunable laser may be continuously swept through available wavelengths and communicating the wavelengths to the at least one resonator to construct concentration profiles in the immediate vicinity of the resonator surface.

The sensitivity of higher order radial modes of sensors under the present invention may be suppressed under alternate embodiments. This is possible, as made clear by the theoretical and experimental discussions above, through adjustment of the refractive index and thickness of the layer. Such suppression allows construction of sensors having a broad range of sensitivity, thus extending the sensor's dynamic range. Further, matching the different radial modes, e.g., TE and TM modes and polarizations, removes ambiguity in the sensing. Moreover, under certain embodiments of the present invention, TE and TM resonance wavelengths may be matched so that circularly polarized WGM may be sustained.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A device for determining the presence and/or concentration profile of a substance in a medium, comprising:
a) at least one whispering gallery mode optical resonator formed of electro-optic material and having a refractive index;
b) at least one optical source in optical communication with the at least one resonator; and
c) at least one dielectric layer surrounding the at least one resonator and having a refractive index that is greater than the refractive index of the resonator.

2. The device of claim 1, wherein the at least one dielectric layer is of uniform thickness.

3. The device of claim 2, wherein the at least one dielectric layer is a fraction of the wavelength of the optical source.

4. The device of claim 1, wherein the at least one dielectric layer is of non-uniform thickness.

5. The device of claim 4, wherein the at least one dielectric layer is a fraction of the wavelength of the optical source.

6. The device of claim 1, wherein the at least one dielectric layer comprises polystyrene.

7. The device of claim 1, wherein the at least one resonator comprises a symmetric geometry.

8. The device of claim 1, wherein the at least one resonator is a sphere.

9. The device of claim 1, wherein the at least one resonator is a disc.

10. The device of claim 1, wherein the at least one resonator is a ring.

11. The device of claim 1, wherein the at least one resonator is a toroid.

12. The device of claim 1, wherein the resonator comprises a material selected from the group consisting of silica, sapphire, borosilicate, and calcium fluoride.

13. The device of claim 1, wherein the at least one dielectric layer comprises zirconia.

14. The device of claim 1, wherein the medium is selected from the group consisting of water, alcohol, chemical solvents and non-biological fluids.

15. The device of claim 1, wherein the medium is selected from the group consisting of whole blood, plasma, urine, interstitial fluid and tears.

16. The device of claim 1, further comprising an inner dielectric layer surrounding the resonator and an outer dielectric layer surrounding the inner dielectric layer.

17. The device of claim 16, further comprising at least a third dielectric layer surrounding the outer dielectric layer, wherein the dielectric layers are concentric and surround the resonator.

18. The device of claim 16, wherein the inner and outer dielectric layers each have different refractive indices.

19. The device of claim 1, wherein the at least one dielectric layer comprises a uniform refractive index over the thickness of the layer.

20. The device of claim 1, wherein the at least one dielectric layer comprises a continuously varying refractive index over the thickness of the layer.

21. The device of claim 1, wherein the at least one resonator comprises TE and TM radial modes and wherein the at least one dielectric layer comprises a birefringent dielectric layer of sufficient birefringence to equalize the evanescent penetration depth of the resonator's TE and TM radial modes.

22. The device of claim 1, wherein the at least one resonator comprises TE and TM radial modes and wherein the at least one dielectric layer comprises a birefringent dielectric layer of sufficient birefringence to equalize the sensitivity of the resonator's TE and TM radial modes to detecting adherent molecules.

23. The device of claim 1, wherein the at least one resonator comprises higher order radial modes and wherein the higher order radial modes are suppressed to extend the sensor's dynamic range.

24. A method for enhancing the sensitivity of whispering-gallery mode photonic sensors for detection of environmental change, comprising the steps of:
a) providing at least one whispering gallery mode optical resonator comprising an electro-optic material and having a refractive index;
b) providing at least one optical source in optical communication with the at least one resonator; and
c) providing at least one dielectric layer, wherein the at least one dielectric layer surrounds the at least one resonator and comprises a refractive index that is greater than the refractive index of the resonator.

25. The method of claim 24, further comprising ensuring that at least one dielectric layer is of uniform thickness.

26. The method of claim 24, further comprising ensuring that the at least one dielectric layer is of non-uniform thickness.

27. The method of claim 24, further comprising ensuring the at least one resonator comprises a symmetric geometry.

28. The method of claim 24, further comprising ensuring that the at least one dielectric layer is comprised of polystyrene.

29. The method of claim 24, further comprising ensuring that the at least one dielectric layer is comprised of zirconia.

30. The method of claim 24, further comprising the steps of:
suppressing sensitivity of higher order radial modes; and
extending the dynamic range of the sensor.

31. The method of claim 24, further comprising the steps of:
matching the sensitivity of at least two of the different radial modes; and
removing the ambiguity due to unassigned radial modes.

32. The method of claim 24, further comprising the steps of:
matching the TE and TM mode sensitivities; and
removing the ambiguity due to unassigned polarization.

33. The method of claim 24, further comprising the step of:
matching the TE and TM resonance wavelengths.

34. The method of claim 24, further comprising the step of:
providing at least one dielectric layer comprising an inner dielectric layer and an outer dielectric layer;
wherein the refractive indices of the inner dielectric layer and the outer dielectric layers differ from each other and wherein the inner dielectric layer surrounds the microsphere and the outer dielectric layer is surrounds the first dielectric layer.

35. A method for enhancing the sensitivity of whispering-gallery mode photonic sensors for detection of concentration profiles of substances and for distinguishing adsorption from uniform refractive index change in the surrounding medium, comprising the steps of:
a) providing at least one whispering gallery mode optical resonator comprising an electro-optic material and having a refractive index;
providing at least one optical source in optical communication with the at least one resonator;
b) providing at least two dielectric layers comprising an inner dielectric layer and an outer dielectric layer, wherein the inner dielectric layer surrounds the at least one resonator and comprises a refractive index that is greater than the refractive index of the resonator and wherein the at outer dielectric layer surrounds the inner dielectric layer and comprises a refractive index that is greater than the refractive index of the resonator; and
c) ensuring that the refractive indices of the inner dielectric layer and the outer dielectric layer differ from each other.

36. The method of claim 35, further comprising the step of:
providing at least three concentric dielectric layers surrounding the resonator.

37. The method of claim 35, wherein the at least one optical source comprises a tunable laser and further comprises selecting discrete wavelengths and optically communicating the discrete wavelengths to the at least one resonator.

38. The method of claim 35, wherein the at least one optical source comprises a tunable laser and further comprises continuously sweeping through available wavelengths and optically communicating the wavelengths to the at least one resonator.

39. A method of sensing materials adsorbed on the surface or near the surface of a whispering-gallery mode photonic sensor, comprising the steps of:
a) providing at least one whispering gallery mode optical resonator comprising an electro-optic material and having a refractive index;
b) providing at least one optical source in optical communication with the at least one resonator; measuring induced frequency shifts in the optical source, wherein the optical source is in communication with the sensor's resonator;
and
c) attenuating the optical source at discrete wavelengths.

40. The method of claim 39, wherein the induced frequency shifts are Raman-induced frequency shifts, wherein the frequency shifts arise by interaction of the optical source with the evanescent wave of the resonator.

41. The method of claim 39, wherein the induced frequency shift arises by interaction of the optical source with the evanescent wave of the resonator.
